(19) United States
(12) Patent Application Publication
(10) Pub. No.: US 2007/0016793 A1
(43) Pub. Date: Jan. 18, 2007

(54) SYSTEM AND METHOD TO DETERMINE A PROXY LOGIN

(76) Inventor: MATTHEW J. INSKO, Milford, OH (US)

Correspondence Address: UGS CORP., 5800 GRANITE PARKWAY, SUITE 600, PLANO, TX, 75024, US

(21) Appl. No.: 11/427,300

(22) Filed: Jun. 28, 2006

Related U.S. Application Data
(60) Provisional application No. 60/595,401, filed on Jun. 30, 2005.

(51) Int. Cl. H04L 9/00

(52) U.S. Cl. 713/182

(57) ABSTRACT

A system, method, and computer program for accessing a secured application by a proxy user, comprising the steps of identifying a proxy user by a first user name and a second user; and entering a first user passcode whereby said proxy user is able to perform operations as said second user. and appropriate means and computer-readable instructions.

### PRIORITY OF APPLICATION

The present application claims priority of U.S. provisional application Ser. No. 60/595,401 filed Jun. 30. 2004, which is incorporated herein by reference.

### TECHNICAL FIELD

This invention relates generally to computer login access by an authorized user. More specifically, this invention relates to a system and method to determine a proxy login.

### BACKGROUND

In corporations around the world, engineers responsible for computer systems, or some aspect of them, are known as system administrators, or sysadmins. These sysadmins, typically have a standard user account to access the computer system, and access to a super user account, known as “root” in UNIX or “admin” in other Operating System vernacular, to give the sysadmin access to all aspects of the computer system.

It is common practice for the sysadmin to login under the standard user account, and then enter a substitute user (“su” command to the become the admin user or any other user. While the sysadmin is the substitute user, the system executes the initial login script and all further commands as if the sysadmin were the substitute user in a separate shell.

A problem, though, is that this technique of becoming the substitute user is a multi-step process and requires the sysadmin to already be logged in. Furthermore, with the exception of becoming the super user, the sysadmin may execute the su command to become another general user, e.g., su other_user, to debug a login issue or other user specific issue at that general user's computer, for example.

Another problem occurs when the sysadmin designates a particular general user to perform operations intended only for a different particular person and has to login first to expose the super user shell so that he may login as the particular person. For example, a temporary contractor needs to work on the finance system for just a few short hours and the sysadmin first logs in under his general user id, then executes the su command to become a user with access to the finance system. Allowing this type of user designation can permit the temporary contractor to exit out of the shell, and have complete access to an unintended user id.

A known solution to this problem is having the sysadmin grant a group permission to a temporary contractor. However the issue of performing tasks as a particular user who is not the temporary contractor is not resolved by this technique.

There is a need for a solution that can provide a sysadmin the ability to execute a proxy login with an administrator-level password to give access to a general user so that the general user may perform operations and act like an authorized user on a temporary per-login basis.

There is also a need for a solution that can provide the ability for a general user to grant proxy access to other non-admin level users, for example a manager who requires updates of a financial system logs into the financial system as a verified financial user where the manager directly has no permissions to access said financial system.

### SUMMARY

To achieve the foregoing, and in accordance with the purpose of the presently preferred embodiment as broadly described herein, the present application provides a method of accessing a secured application by a proxy user, comprising the steps of: identifying a proxy user by a first user name and a second user; and entering a first user passcode whereby said proxy user is able to perform operations as said second user. The method further comprising the step of validating said passcode. The method further comprising the step of granting access to a secured application according to said second user credentials. The method, wherein said proxy user is identified by a concatenation of said first user name and said second user name.

An advantage of the presently preferred embodiment is to provide a method of accessing a secured application by a proxy user, comprising the step of: accepting entry of a user passcode pair and a proxy username. The method, further comprising the step of validating said passcode. The method, further comprising the step of granting access to a secured application according to said passcode.

Another advantage of the presently preferred embodiment is to provide a computer-program product tangibly embodied in a machine readable medium to perform a method to determine a proxy login, comprising: instructions for identifying a proxy user by a first user name and a second user; and instructions for entering a first user passcode whereby said proxy user is able to perform operations as said second user. The computer-program product, further comprising instructions for validating said passcode. The computer-program product, further comprising instructions for granting access to a secured application according to said second user credentials. The computer-program product, wherein said proxy user is identified by a concatenation of said first user name and said second user name.

And yet another advantage of the presently preferred embodiment is to provide a computer-program product tangibly embodied in a machine readable medium to perform a method of accessing a secured application by a proxy user, comprising the step of instructions for accepting entry of a user passcode pair and a proxy username. The computer-program product, further comprising instructions for validating said passcode. The computer-program product, further comprising instructions for granting access to a secured application according to said passcode.

And still another advantage of the presently preferred embodiment is to provide a data processing system having at least a processor and accessible memory to implement a method to determine a proxy login, comprising means for identifying a proxy user by a first user name and a second user; and means for entering a first user passcode whereby said proxy user is able to perform operations as said second user.

And still yet another advantage of the presently preferred embodiment is to provide a data processing system having at least a processor and accessible memory to implement a method of accessing a secured application by a proxy user, comprising means for accepting entry of a user passcode pair and a proxy username.

Other advantages of the presently preferred embodiment will be set forth in part in the description and in the drawings that follow, and, in part will be learned by practice of the invention.

The presently preferred embodiment will now be described with reference made to the following Figures that form a part hereof. It is understood that other embodiments may be utilized and changes may be made without departing from the scope of the present invention.

### BRIEF DESCRIPTION OF THE DRAWINGS

A presently preferred embodiment will hereinafter be described in conjunction with the appended drawings, wherein like designations denote like elements, and:

FIG. 1 is a block diagram of a computer environment in which the presently preferred embodiment may be practiced; and

FIG. 2 a flow diagram for a proxy authentication schema.

### DETAILED DESCRIPTION OF THE PREFERRED EMBODIMENTS

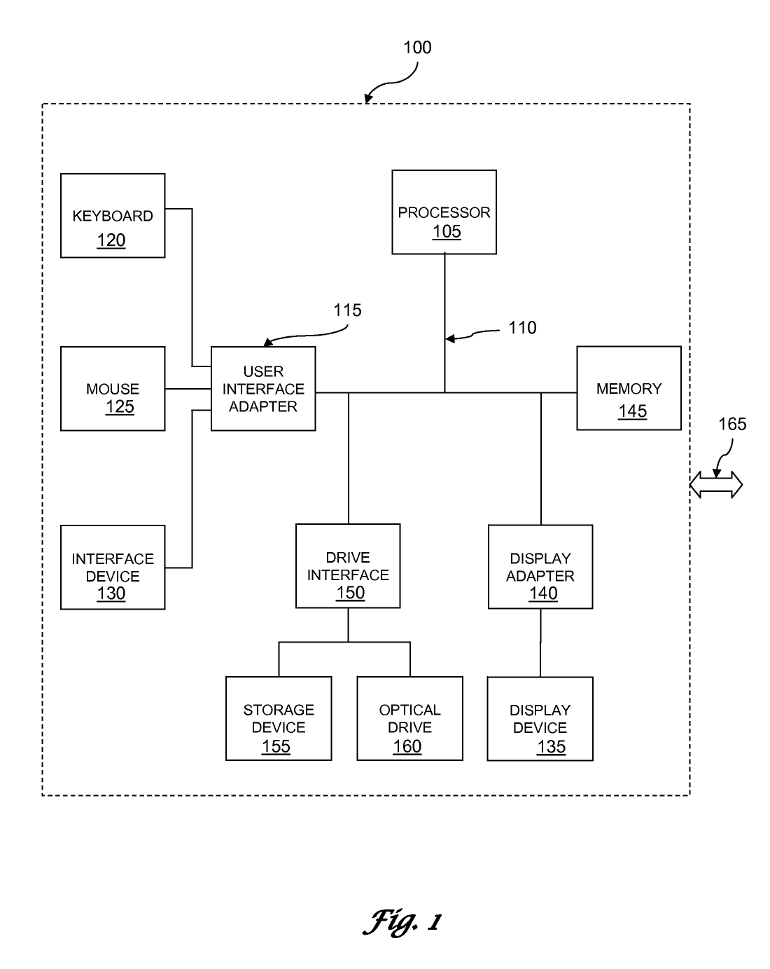

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method to determine a proxy login. Now therefore, in accordance with the presently preferred embodiment, an operating system executes on a computer, such as a general-purpose personal computer. FIG. 1 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implementation particular abstract data types. and the presently preferred embodiment may be performed in any of a variety of known computing environments.

With reference to FIG. 1, an exemplary system for implementing the presently preferred embodiment includes a general-purpose computing device in the form of a computer 100, such as a desktop or laptop computer, including a plurality of related peripheral devices (not depicted). The computer 100 includes a microprocessor 105 and a bus 110 employed to connect and enable communication between the microprocessor 105 and a plurality of components of the computer 100 in accordance with known techniques. The bus 110 may be any of several types of bus structures including a memory bus or memory controller, a peripheral bus, and a local bus using any of a variety of bus architectures. The computer 100 typically includes a user interface adapter 115, which connects the microprocessor 105 via the bus 110 to one or more interface devices, such as a keyboard 120, mouse 125, and/or other interface devices 130, which can be any user interface device, such as a touch sensitive screen, digitized pen entry pad, etc. The bus 110 also connects a display device 135, such as an LCD screen or monitor, to the microprocessor 105 via a display adapter 140. The bus 110 also connects the microprocessor 105 to a memory 145, which can include ROM, RAM, etc.

The computer 100 further includes a drive interface 150 that couples at least one storage device 155 and/or at least one optical drive 160 to the bus. The storage device 155 can include a hard disk drive, not shown, for reading and writing to a disk, a magnetic disk drive, not shown, for reading from or writing to a removable magnetic disk drive. Likewise the optical drive 160 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 100.

The computer 100 can communicate via a communications channel

with other computers or networks of computers. The computer 100 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 145 of the computer 100. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

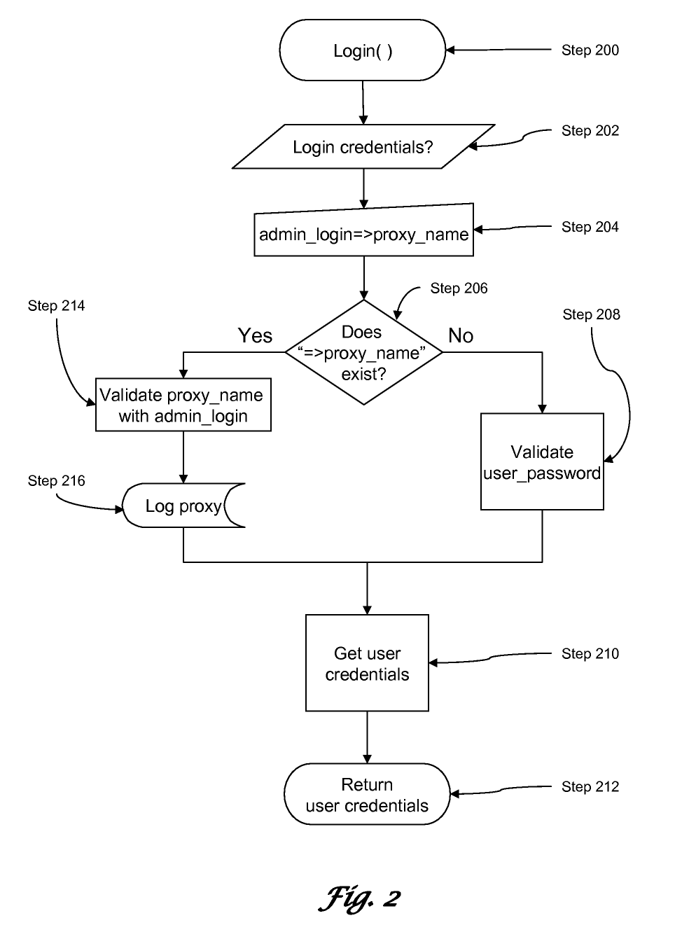

Referring to FIG. 2, which depicts a flow diagram for a proxy authentication schema to a secured application, where the secured application can be an operating system, a single application or process, for example, an accounting program or any other. A user with login credentials accesses a secured application via a login method (Step 200). The user enters a user name and a user password, as is well understood in the art (Step 205). Should the user require access as a proxy user, the user can enter his or her user name followed by a proxy user selection method. Proxy user selection may be indicated by use of a proxy symbol, such as an “=” or “=>”. In the presently preferred embodiment, the proxy symbol may be followed by a proxy username, where the proxy user name is another username. In an alternate embodiment, the user may chose the proxy user name from a drop-down list or another selection method (Step 210). The user can be an administrator level user, or “admin” user, or someone to whom rights have been granted to act on another's behalf, like a delegate.

The presently preferred embodiment determines whether the proxy user selection method is selected (Step 215), and if not the application performs the following: it validates the user's password (Step 220), authenticates the user utilizing techniques well understood in the industry (Step 225), retrieves the user's login credentials (Step 230). The user is granted access along with the credentials to the user (Step 235), so that the user may use the secured application.

If, however, the proxy user selection method is present, the application performs the following: it validates the user's password (Step 240), logs an entry that records the user logging in as the proxy user(Step 245), authenticates the user utilizing techniques well understood in the industry (Step 225), retrieves the proxy user's login credentials (Step 230), and grants access along with the proxy user's credentials to the user (Step 235), so that the user may use the secured application as the proxy user. The user may now perform operations in the secured application without the need to know or reset the proxy user's password.

The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A number of embodiments have been described. It will be understood that various modifications may be made without departing from the spirit and scope of the presently preferred embodiment. Therefore, other implementations are within the scope of the following claims.

What is claimed is:

1. A method of accessing a secured application by a proxy user, comprising the steps of:
identifying a proxy user by a first user name and a second user; and
entering a first user passcode whereby said proxy user is able to perform operations as said second user.

2. The method of claim 1, further comprising the step of validating said passcode.

3. The method of claim 1, further comprising the step of granting access to a secured application according to said second user credentials.

4. The method of claim 1, wherein said proxy user is identified by a concatenation of said first user name and said second user name.

5. A method of accessing a secured application by a proxy user, comprising the steps of:
accepting entry of a user passcode pair and a proxy username.

6. The method of claim 5, further comprising the step of validating said passcode.

7. The method of claim 5, further comprising the step of granting access to a secured application according to said passcode.

8. A computer-program product tangibly embodied in a machine readable medium to perform a method to determine a proxy login, comprising:
instructions for identifying a proxy user by a first user name and a second user; and
instructions for entering a first user passcode whereby said proxy user is able to perform operations as said second user.

9. The computer-program product of claim 8, further comprising instructions for validating said passcode.

10. The computer-program product of claim 8, further comprising instructions for granting access to a secured application according to said second user credentials.

11. The computer-program product of claim 8, wherein said proxy user is identified by a concatenation of said first user name and said second user name.

12. A computer-program product tangibly embodied in a machine readable medium to perform a method of accessing a secured application by a proxy user, comprising:
instructions for accepting entry of a user passcode pair and a proxy username.

13. The computer-program product of claim 12, further comprising instructions for validating said passcode.

14. The computer-program product of claim 12, further comprising instructions for granting access to a secured application according to said passcode.

15. A data processing system having at least a processor and accessible memory to implement a method to determine a proxy login, comprising:
means for identifying a proxy user by a first user name and a second user; and
means for entering a first user passcode whereby said proxy user is able to perform operations as said second user.

16. A data processing system having at least a processor and accessible memory to implement a method of accessing a secured application by a proxy user, comprising:
means for accepting entry of a user passcode pair and a proxy username.
